(19) United States
(12) Patent Application Publication
(10) Pub. No.: US 2006/0119664 A1
(43) Pub. Date: Jun. 8, 2006

(54) Print head assembly

(75) Inventor: Jin-Sheng Lai, Hsi Chih City (TW)

Correspondence Address: DENNISON, SCHULTZ, DOUGHERTY;& MACDONALD, SUITE 105, 1727 KING STREET, ALEXANDRIA, VA, 22314-2700, US

(73) Assignee: GREAT COMPUTER CORPORATION

(21) Appl. No.: 11/002,128

(22) Filed: Dec. 3, 2004

(51) Int. Cl. B41J 2/04

(52) U.S. Cl. 347/54

(57) ABSTRACT

A print head assembly having a base, the base is movable on a slide platform of a printer, the front end of the base is fixedly provided with an ink jet component and a heat transfer printing component; the ink jet component has thereon a plurality of ink cartridges for ink jetting, the heat transfer printing component can do monochrome transfer printing on an article; the two components act sequentially during the base moves on the slide platform of the printer, thereby the article to be printed can have both ink jet color luster and transfer printing gloss. The present invention is applicable for use as a print head assembly of a printer.

### BACKGROUND OF THE INVENTION

1. Field of the Invention

The present invention is related to a print head assembly, and especially to a structure provided on the front end of a base thereof with an ink jet component and a heat transfer printing component, the structure can render the ink jet component and the heat transfer printing component act sequentially during it moves on a slide platform of a printer, thereby an article to be printed can have both ink jet color luster and transfer printing gloss. The present invention is applicable to using as a print head assembly of a printer.

2. Description of the Prior Art

Conventional modes of printing are divided generally into the ink jet mode, the heat transfer printing mode and the spot array mode, they are different in printing effects. The earliest printers of the spot array mode appearing in the markets use simpler mechanical principles and cost inexpensive, they are the pioneers of printers. However, they are inferior in printing effects, and are unable to give colors of multiple levels. Manufacturers kept on studying and developing till printers of the ink jet mode and the heat transfer printing mode appeared in the markets, and there came the abundant and multivariate times of color effect.

Printers of the ink jet mode can spray colors of different concentrations at a position with different ink cartridges to generate desired colors; such an ink jet mode gives richer colors, but is unable to give bright metallic glosses (such as of gold and silver). On the contrary, a printer of the heat transfer printing mode can generate metallic color luster on papers by using transferring color films, the colors of images thereon are more brilliant and glossy and thereby are very desired by the people in the advertisement business. However, printers of the heat transfer printing mode generally do printing each with a monochromatic transfer printing color film, the colors they print have inferior color resolutions. While the printers of the heat transfer printing mode each can also use several transferring color films for color matching in practical operation, but this mode will largely increase the cost of printing.

The above two kinds of printers are respectively advantageous in their treatments of images, but they still have their respectively inadequacies. By the fact that every print head of printers is limited to being a module of singular function, a user only can select one mode, i.e. either the ink jet mode or the heat transfer printing mode, this is quite inconvenient, and is unable to make perfect of the printing qualities of images on the surfaces of articles.

In view of the defects, to render a print head assembly able to not only make an article to be printed having both ink jet color luster and transfer printing gloss, but also make itself control flexibly to decide to use the function of the ink jet mode or the heat transfer printing mode, the inventor provides the present invention based on his professional experience of years in nonstop studying, improvement and developing.

### SUMMARY OF THE INVENTION

The primary objective of the present invention is to provide a print head assembly having on a base thereof an ink jet component and a heat transfer printing component, the two components act sequentially on the base while the print head assembly moves on a slide platform of a printer, thereby an article to be printed can have both ink jet color luster and transfer printing gloss.

The second objective of the present invention is to provide a print head assembly of which either the ink jet component or the heat transfer printing component on the base can be selected under control for printing, thereby a user can use them with flexibility.

To achieve the above stated objectives, the print head assembly of the present invention comprises a base, an ink jet component and at least a heat transfer printing component; the base is movably connected to a slide platform of a printer, the ink jet component is fixed on the front end of the base and has thereon a plurality of ink cartridges; the heat transfer printing component is fixed on the front end of the base and closely contiguous to one lateral side of the ink jet component.

Thereby, when the base moves on the slide platform of the printer, the ink jet component and the heat transfer printing component act sequentially, hence an article to be printed can have both effects of ink jet color luster and transfer printing gloss. Thereby either the ink jet component or the heat transfer printing component can be used solely; this can increase the flexibility of use of them.

The present invention will be apparent after reading the detailed description of the preferred embodiment thereof in reference to the accompanying drawings.

### BRIEF DESCRIPTION OF THE DRAWINGS

FIG. 1 is a perspective view of a first embodiment of the present invention;

FIG. 2 is a top view showing the first embodiment of the present invention is connected with a printer;

FIG. 3 is a schematic view showing use of the first embodiment of the present invention;

FIG. 4 is another schematic view showing use of the first embodiment of the present invention;

FIG. 5 is a side view showing a second embodiment of the present invention.

### DETAILED DESCRIPTION OF THE PREFERRED EMBODIMENT

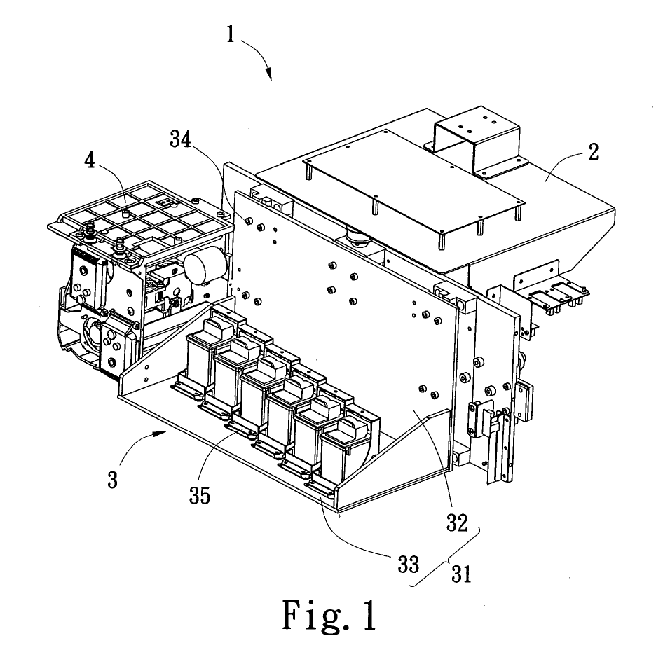

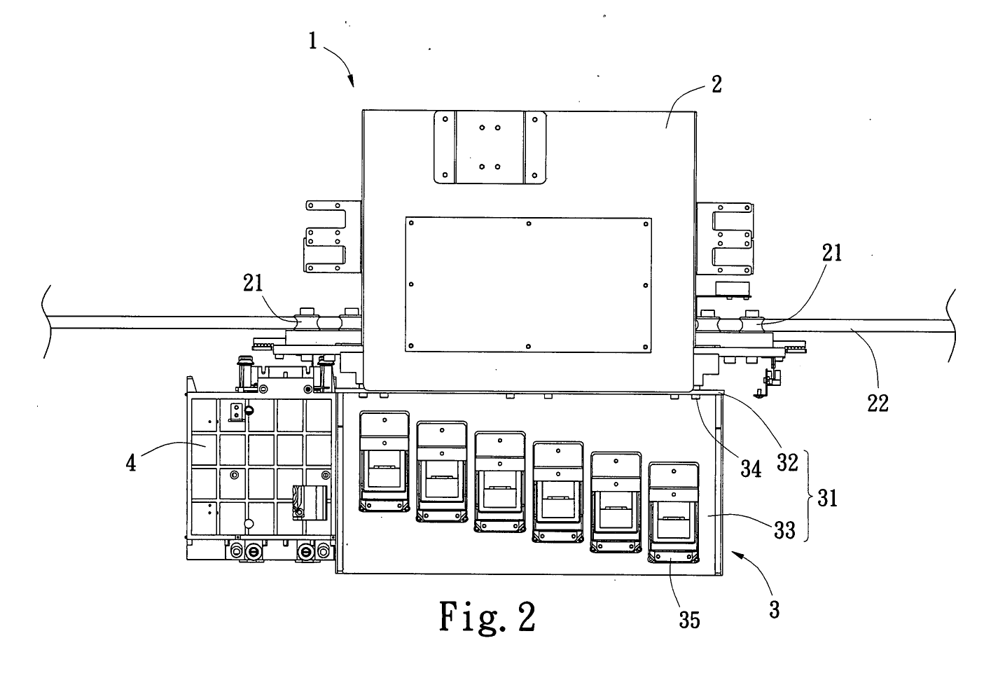

Referring to FIGS. 1, 2 showing the first embodiment of print head assembly 1 of the present invention, the print head assembly 1 comprises a base 2, an ink jet component 3 and at least a heat transfer printing component 4.

The base 2 is provided on the right and left ends thereof with rollers 21 in connection with a slide platform 22 (in this embodiment, it is a slide rail) of the printer, thereby the base 2 can move right and left.

The ink jet component 3 includes an “L” shaped fixing seat 31 which has an upright plate 32 as a positioning part; the bottom end of the upright plate 32 has a bracket 33 extending horizontally outwardly as a support part. The upright plate 32 is connected to the front end of the base 2 by means of a bolt 34; while the bracket 33 of the fixing seat 31 braces up and fixes a plurality of ink cartridges 35; there are 6 ink cartridges 35 in this embodiment, but in use, they can be four or some other amount in combination.

The heat transfer printing component 4 is a single module; its rear end is fixedly connected to the front end of the base 2 and closely contiguous to one lateral side of the ink jet component 3.

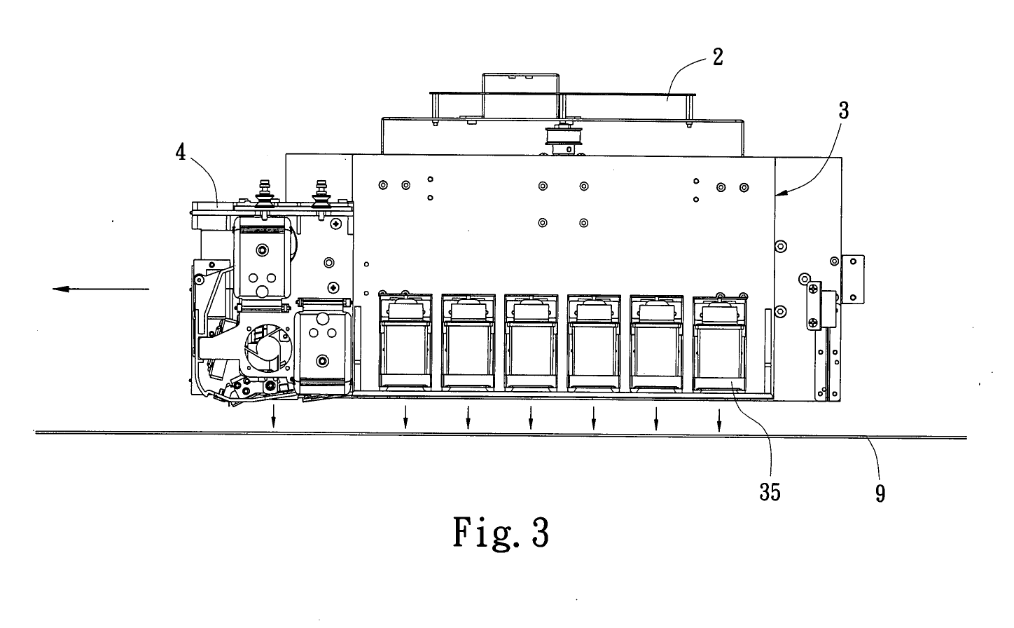

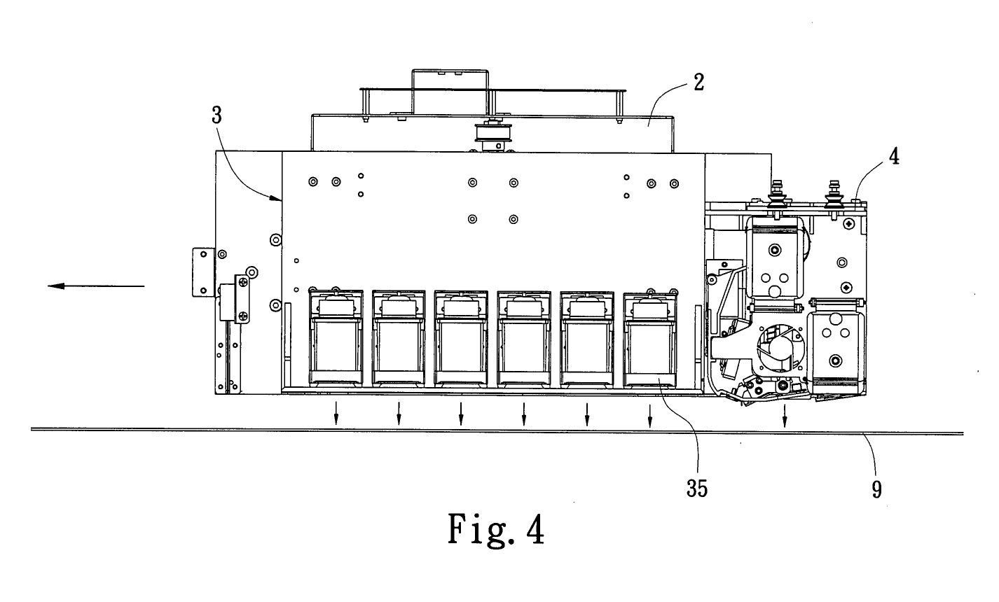

Referring to FIG. 3, when the printer starts to print, the base 2 moves right and left under control; firstly, the heat transfer printing component 4 is actuated to control transfer printing of its color films therein (not shown), and very closely, the ink jet component 3 is actuated to control ejection of ink of the ink cartridges 35, so that an image is transfer printed on the surface of an article 9 (such as a paper), the article 9 being printed hence gets the effects of both ink jet color luster and transfer printing gloss. As shown in FIG. 4, the positions of the heat transfer printing component 4 and the ink jet component 3 fixed can be exchanged, that is, the ink cartridges 35 can eject ink in the first place, and then transfer printing proceeds in the heat transfer printing mode.

The ink jet component 3 and the heat transfer printing component 4 can have various modes of arrangement; nevertheless, these two can form both ink jet color luster and transfer printing gloss when in application on a single article 9. The present invention can select a single mode from the ink jet mode and the heat transfer printing mode, this can overcome the unnecessary waste of material.

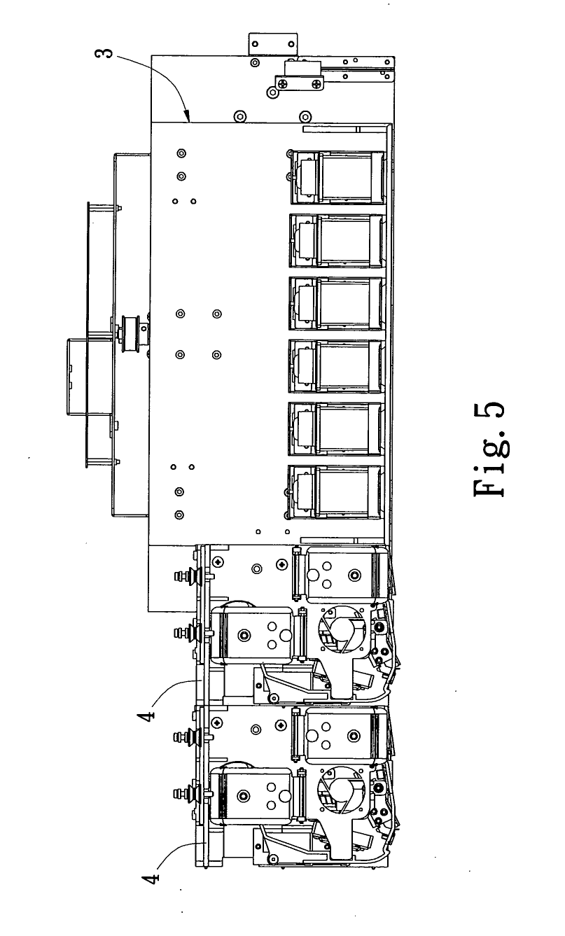

Referring to FIG. 5 showing a second embodiment of the present invention, wherein there are two sets of heat transfer printing components 4, one set provides golden color, the other provides silver color, so that the effect of transfer printing for images can be enhanced. There can also be multiple sets of heat transfer printing components 4 for a print head assembly, they are respectively allocated at two lateral sides of the ink jet component 3 in order to meet requirements of a user.

Therefore, the present invention has the following advantages:
1. By combination of the ink jet component and the heat transfer printing component, the present invention can have both the advantages of the ink jet and the heat transfer printing modes, it not only gives images colors of multiple levels, but also can give bright metallic glosses; thereby image quality is elevated.
2. The ink jet component and the heat transfer printing component of the present invention can be allocated in pursuance of demands; thereby the present invention can meet practical requirements.
3. The ink jet component and the heat transfer printing component of the present invention can be operated simultaneously or singularly under control, this can increase the flexibility of use of them.

In conclusion, according to the above disclosure, the present invention surely can get its expected object to provide a print head assembly, it not only can have both ink jet color luster and transfer printing gloss on an article to be printed, but also can allow the ink jet component and the heat transfer printing component to be operated singularly under control, this can increase the flexibility of use.

1. A print head assembly comprising:
a base movably connected with a slide platform of a printer;
an ink jet component fixedly provided on said base, said ink jet component is provided thereon with a plurality of ink cartridges; and
at least a heat transfer printing component closely contiguous to a lateral side of said ink jet component;
thereby said ink jet component and said heat transfer printing component act sequentially, an article to be printed thus has both effects of ink jet color luster and transfer printing gloss.

2. The print head assembly as in claim 1, wherein, said ink jet component further is provided with a fixing seat having an upright plate as a positioning part and a horizontally extending support part; said positioning part is connected to a front end of said base, while said support part braces up and fixes said plurality of ink cartridges.

3. The print head assembly as in claim 1, wherein, said heat transfer printing component contiguous to said lateral side of said ink jet component is fixed on a front end of said base.
